(19) United States
(12) Patent Application Publication
(10) Pub. No.: US 2025/0350865 A1
(43) Pub. Date: Nov. 13, 2025

(54) IMAGE CAPTURING APPARATUS

(71) Applicant: CANON KABUSHIKI KAISHA, Tokyo (JP)

(72) Inventors: YUKI TSUJIMOTO, Tokyo (JP); YUDAI ITOI, Tokyo (JP); NOBUKI FUKUNAGA, Kanagawa (JP)

(21) Appl. No.: 19/188,252

(22) Filed: Apr. 24, 2025

(30) Foreign Application Priority Data
May 8, 2024 (JP) 2024-076088

(51) Int. Cl. H04N 25/709; H04N 23/68; H04N 25/76; H04N 25/79

(52) U.S. Cl. CPC H04N 25/709; H04N 25/76; H04N 23/687; H04N 25/79

(57) ABSTRACT

An image capturing apparatus includes a first circuit board mounted with an image sensor, a second circuit board that is fixedly connected to the first circuit board and supplies power to the first circuit board, a main circuit board that supplies power to the second circuit board, a flexible circuit board connecting the main circuit board and the second circuit board, wherein the main circuit board supplies a first voltage higher than a voltage at which the image sensor operates to the second circuit board via the flexible circuit board, and the second circuit board includes a stepdown circuit that converts the first voltage into a second voltage lower than the first voltage and outputs the second voltage to the image sensor, and the stepdown circuit is a DCDC converter including an inductor.

### BACKGROUND OF THE INVENTION

### Field of the Invention

The present invention relates to a technique of supplying power to an image sensor in an image capturing apparatus.

### Description of the Related Art

In an image capturing apparatus such as a known single lens reflex camera or a mirrorless camera, a DCDC converter that supplies power to an image sensor is arranged on a circuit board different from an imaging circuit board mounted with the image sensor due to concern about an influence of magnetic noise on an image.

In recent years, in order to achieve an image blur correction function, the imaging circuit board is generally configured to move physically. Therefore, it is desirable that a flexible circuit board connected to the imaging circuit board is provided with a long extra length so as not to hinder the movement of the imaging circuit board, and the wiring width is narrowed and the thickness is also thinned as much as possible.

On the other hand, in recent years, the current flowing through the flexible circuit board for supplying power to the image sensor tends to increase with an increase in reading speed of the image sensor and an increase in the number of pixels. The increase in the current flowing through the flexible circuit board causes problems such as image quality deterioration due to an increase in magnetic radiation. An increase in current and an increase in a heat generation amount due to wiring resistance or the like also cause image quality deterioration.

Japanese Patent Laid-Open No. 2022-172947 describes, as a method of supplying power to an image sensor, a method of suppressing a current of a first power supply circuit by providing a second power supply circuit in addition to the first power supply circuit.

However, the technique disclosed in Japanese Patent Laid-Open No. 2022-172947 cannot reduce the total amount of current flowing through the flexible circuit board.

### SUMMARY OF THE INVENTION

The present invention has been made in view of the above-described problems, and reduces the total amount of current flowing through the flexible circuit board and suppresses image quality deterioration.

According to an aspect of the present invention, there is provided an image capturing apparatus comprising: a first circuit board mounted with an image sensor; a second circuit board that is fixedly connected to the first circuit board and supplies power to the first circuit board; a main circuit board that supplies power to the second circuit board; a flexible circuit board connecting the main circuit board and the second circuit board, wherein the main circuit board supplies a first voltage higher than a voltage at which the image sensor operates to the second circuit board via the flexible circuit board, and the second circuit board includes a stepdown circuit that converts the first voltage into a second voltage lower than the first voltage and outputs the second voltage to the image sensor, and the stepdown circuit is a DCDC converter including an inductor.

Further features of the present invention will become apparent from the following description of exemplary embodiments with reference to the attached drawings.

### BRIEF DESCRIPTION OF THE DRAWINGS

FIG. 1 is a block diagram illustrating a configuration of an image capturing apparatus according to a first embodiment of the present invention.

FIGS. 2A and 2B are views illustrating a mounting configuration of an image capturing apparatus.

FIG. 3 is a view illustrating an example of an imaging power supply unit and a peripheral circuit configuration.

FIG. 4 is a view illustrating another example of the imaging power supply unit and the peripheral circuit configuration.

FIG. 5 is a flowchart showing control content of the imaging power supply unit.

FIG. 6 is a view illustrating another example of the imaging power supply unit and the peripheral circuit configuration.

FIG. 7 is a view illustrating another example of the imaging power supply unit and the peripheral circuit configuration.

FIGS. 8A and 8B are flowcharts showing control content of the imaging power supply unit.

FIG. 9 is a view illustrating a layout of components of the imaging power supply unit arranged on the imaging circuit board of FIGS. 2A and 2B.

FIGS. 10A and 10B are views illustrating a mounting configuration of an image capturing apparatus in a second embodiment.

FIG. 11 is a view illustrating a layout of components of the imaging power supply unit arranged on an imaging power supply circuit board of FIGS. 10A and 10B.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

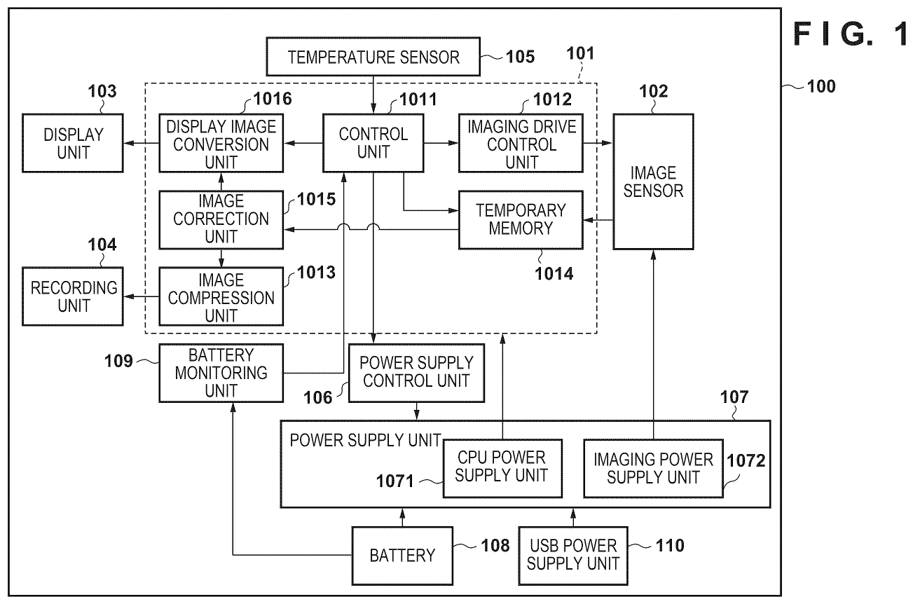

FIG. 1 is a block diagram illustrating the configuration of an image capturing apparatus 100 according to the first embodiment of the present invention.

In FIG. 1, an imaging drive control unit 1012 controls an image sensor 102 based on a command from a control unit 1011 in a central processing unit (CPU) 101 that controls the entire image capturing apparatus 100.

The image sensor 102 is, for example, a CMOS image sensor, and a light receiving element and an amplifier that amplifies an electric signal are arranged for each pixel. In the present embodiment, the image sensor 102 is a CMOS image sensor of a stacked type, and is configured by arranging a wiring layer for reading pixel information on the back surface of the pixel. The CMOS image sensor of the stacked type has a characteristic of being hardly affected by the magnetic field because the wiring length of a circuit unit is shorter than that of a non-stacked sensor.

The image sensor 102 photoelectrically converts the light received from a subject in each pixel, and converts an analog signal thereof into digital data by an A/D converter in the image sensor 102. Image data based on the digital data obtained from each pixel is stored in a temporary memory 1014 in the CPU 101.

In a case of a shooting standby state in which a live image (live view image) is displayed, image data output from the image sensor 102 is stored in the temporary memory 1014 in accordance with a thinning drive command for a live image from the control unit 1011. The image data stored in the temporary memory 1014 is subjected to image correction processing by an image correction unit 1015, then converted into display data by a display image conversion unit 1016, sent to a display unit 103, and displayed as a live view image.

In a case where a user presses a release button, image data is output from the image sensor 102 subjected to drive control for main shooting by an instruction of the imaging drive control unit 1012. The image data stored in the temporary memory 1014 is corrected by the image correction unit 1015, subjected to compression processing for recording (JPEG encoding processing) by an image compression unit 1013, sent to a recording unit 104, and recorded as a still image.

In a case where the user presses a moving image recording button, image data of a plurality of frames are sequentially output continuously from the image sensor 102 subjected to drive control for a moving image by an instruction from the imaging drive control unit 1012. The image data of each frame stored in the temporary memory 1014 is corrected by the image correction unit 1015, further subjected to compression processing for recording a moving image by the image compression unit 1013, and recorded as a moving image in the recording unit 104. Note that for simplification, although not illustrated in FIG. 1, the image capturing apparatus 100 also includes an operation unit for user's operation input.

Typical operation modes of the image capturing apparatus 100 include a still image mode for still image shooting and a moving image mode for moving image shooting.

The still image mode includes a single shooting mode in which one still image is shot each time the release button is pressed once, and a continuous shooting mode in which still images are continuously acquired while the release button is pressed. The continuous shooting mode includes a high-speed continuous shooting mode in which the number of shot images per unit time is larger and a low-speed continuous shooting mode in which the number of shot images per unit time is relatively small.

The moving image mode includes a plurality of operation modes in which the number of pixels of a moving image to be recorded is different. The moving image mode includes, for example, an 8 K recording mode in which one frame is horizontal 7680 pixels×vertical 4320 pixels, a 4 K recording mode in which one frame is horizontal 3840 pixels×vertical 2160 pixels, and a full HD (FHD) recording mode in which one frame is horizontal 1920 pixels×vertical 1080 pixels. In the moving image mode, the frame rate can also be changed. For example, in the moving image mode, any of 120 frames/second (fps), 60 fps, and 30 fps can be set. The operation mode of the image capturing apparatus 100 described above may be changed according to a user's operation, or the control unit 1011 may automatically change the operation mode to an operation mode optimal for the user.

A temperature sensor 105 is arranged in the image capturing apparatus 100 and outputs temperature data in the vicinity of the temperature sensor 105. The control unit 1011 can estimate the temperature of an arbitrary position of the image capturing apparatus 100 based on the output data of the temperature sensor 105. The number of temperature sensors 105 is not limited to one, and two or more temperature sensors may be arranged. The control unit 1011 can estimate the temperature of the image capturing apparatus 100 in more detail based on the output data of the two or more temperature sensors 105. The control unit 1011 can change the control of the image capturing apparatus 100 according to temperature information. For example, in a case where the estimated temperature of the image sensor 102 exceeds a predetermined temperature, the control unit 1011 sends a command to the imaging drive control unit 1012 to stop the image capturing operation. At the same time, the control unit 1011 sends a command to a power supply control unit 106 to turn off an imaging power supply unit 1072. This can safely stop the image capturing operation when the image sensor 102 falls into a temperature state outside the usable range.

The power supply control unit 106 controls a power supply unit 107 based on a command from the control unit 1011. For example, the power supply control unit 106 performs on/off control, change of output voltage, and the like on each power supply unit in the power supply unit 107. FIG. 1 illustrates the power supply control unit 106 as a functional block different from the CPU 101, but the power supply control unit 106 may be configured in the CPU 101. Alternatively, the control unit 1011 may be configured to directly control the power supply unit 107.

The power supply unit 107 has a role of converting electric power supplied from a battery 108 or a USB power supply unit 110 into necessary voltage and current and supplying the converted electric power to each element of the image capturing apparatus 100. A CPU power supply unit 1071 is a power supply circuit that supplies power to the CPU 101. The imaging power supply unit 1072 is a power supply circuit that supplies power to the image sensor 102. The imaging power supply unit 1072 may include not only one power supply circuit but also a plurality of power supply circuits. FIG. 1 illustrates only the CPU power supply unit 1071 and the imaging power supply unit 1072 in the power supply unit 107, but a power supply that supplies power to the display unit 103, the recording unit 104, and other devices may be included.

The battery 108 corresponds to a power supply source of the image capturing apparatus 100, and is, for example, a removable lithium ion battery. In place of the lithium ion battery, a DC coupler can be inserted into a mounting portion of the battery 108. The DC coupler is a power supply adapter that supplies a necessary voltage to a camera from a commercial power supply via an ACDC adapter.

A battery monitoring unit 109 monitors the voltage and discharge current of the battery 108 and transmits information to the control unit 1011. The battery monitoring unit 109 can also calculate the internal resistance of the battery 108 from the discharge current and the voltage drop amount of the battery 108. Based on the battery information provided from the battery monitoring unit 109, the control unit 1011 changes control, for example, to bring the image capturing apparatus 100 into a low power consumption state in a case where the remaining capacity of the battery 108 is small or in a case where the internal resistance is increased.

The USB power supply unit 110 includes a USB Type-C connector and receives power from a power supply device connected to the connector in accordance with the USB Power Delivery standard. The USB power supply unit 110 outputs, to the power supply unit 107, the power received from the connected power supply device. The power supply device connected to the USB power supply unit 110 is, for example, a power bank or an AC adapter including a USB cable. The image capturing apparatus 100 can also operate using power supplied from not the battery 108 but the USB power supply unit 110.

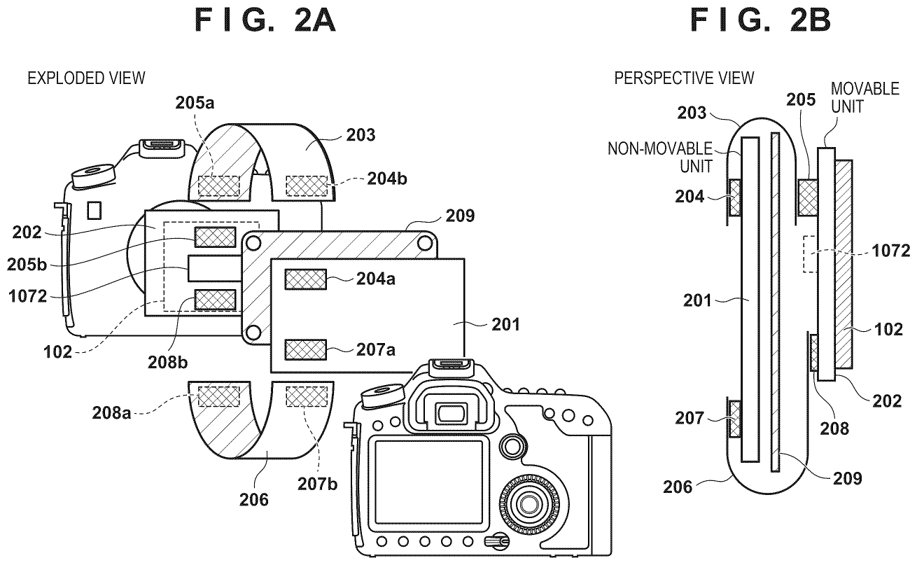

Next, FIGS. 2A and 2B are an exploded view and a perspective view illustrating a mounting configuration of the image capturing apparatus.

A main circuit board 201 and an imaging circuit board 202 are arranged in a housing of the image capturing apparatus 100. The main circuit board 201 is a control circuit board mounted with the CPU 101 and the power supply unit 107 of FIG. 1. The imaging circuit board 202 is mounted with the image sensor 102 and the imaging power supply unit 1072 of FIG. 1. In order for the image sensor 102 to efficiently capture light, the imaging circuit board 202 is arranged on a side closer to a lens than the main circuit board 201.

A chassis 209 is connected to the main circuit board 201 and plays a role of enhancing rigidity and releasing heat to the housing of the image capturing apparatus 100.

Power is supplied from the power supply unit 107 on the main circuit board 201 to the imaging power supply unit 1072 on the imaging circuit board 202 through the following path. First, an imaging power supply flexible printed circuit (hereinafter FPC) 203 is connected to the main circuit board 201 via imaging power supply MAIN connectors 204 (204a and 204b). The imaging power supply FPC 203 is connected to the imaging circuit board 202 via imaging power supply IMG connectors 205 (205a and 205b). The imaging power supply FPC 203 has a power transmission line for transmitting power from the main circuit board 201 to the imaging circuit board 202. Then, power is supplied from the power supply unit 107 mounted on the main circuit board 201 to the imaging power supply unit 1072 through a path of the connectors 204a and 204b→the FPC 203→the IMG connectors 205a and 205b.

Transmission of a data signal from the image sensor 102 on the imaging circuit board 202 to the CPU 101 on the main circuit board 201 and transmission of a control signal from the CPU 101 to the image sensor 102 are performed through the following path. First, an imaging signal FPC 206 is connected to the imaging circuit board 202 via imaging signal IMG connectors 208 (208a and 208b). The imaging signal FPC 206 is connected to the main circuit board 201 via imaging signal MAIN connectors 207 (207a and 207b). The imaging signal FPC 206 includes a communication line for transmitting image data and other data from the imaging circuit board 202 to the main circuit board 201. The imaging signal FPC 206 includes a communication line for transmitting a control signal and other data from the main circuit board 201 to the imaging circuit board 202. Then, a data signal of the image sensor 102 is transmitted to the CPU 101 via the main circuit board 201 through a path of the connectors 208a and 208b→the FPC 206→the connectors 207a and 207b. A control signal of the CPU 101 is transmitted to the image sensor 102 through the reverse path.

The image capturing apparatus 100 is equipped with an image blur correction mechanism that detects camera shake and operates (moves) the imaging circuit board 202 according to the detection amount. In the image capturing apparatus 100, the imaging circuit board 202 is a movable unit that can physically move for image blur correction. On the other hand, the main circuit board 201 and the chassis 209 are non-movable units. The imaging power supply FPC 203 and the imaging signal FPC 206 that connect the movable unit and the non-movable units are made of a sufficiently soft material. The imaging power supply FPC 203 connects the main circuit board 201, which is a non-movable unit, and the imaging circuit board 202, which is a movable unit, via the imaging power supply MAIN connectors 204 (204a and 204b) and the imaging power supply IMG connectors 205 (205a and 205b). The imaging signal FPC 206 connects the main circuit board 201, which is a non-movable unit, and the imaging circuit board 202, which is a movable unit, via the imaging signal MAIN connectors 207 (207a and 207b) and the imaging signal IMG connectors 208 (208a and 208b).

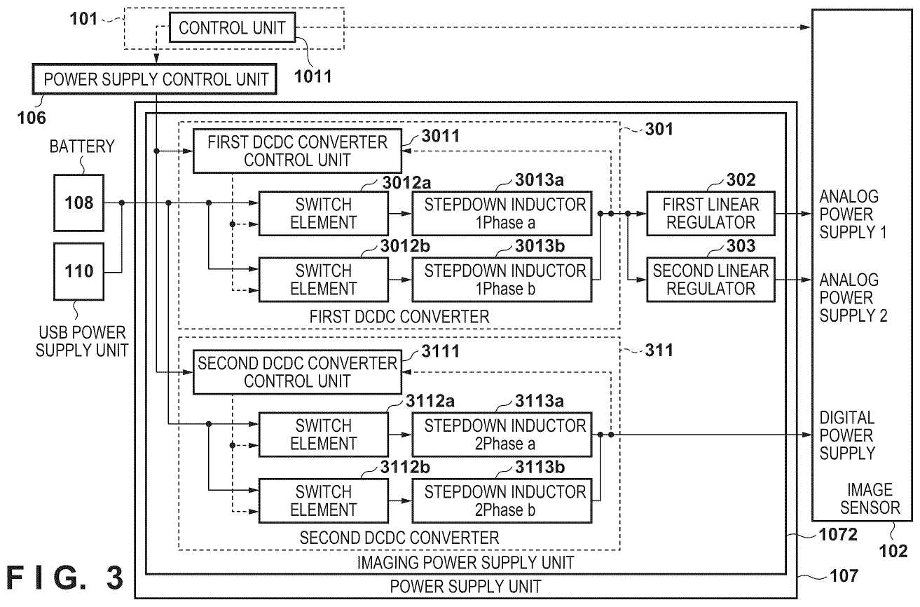

FIG. 3 is a view illustrating an example of the imaging power supply unit 1072 of FIGS. 2A and 2B and a peripheral circuit configuration. The control unit 1011, the image sensor 102, the power supply control unit 106, the battery 108, and the USB power supply unit 110 are the same as those in FIG. 1.

When the battery 108 has two cells, the voltage from the battery 108 is about 5 V to 8.4 V. The voltage output from the USB power supply unit 110 varies depending on the power supply capability of the power supply device connected to the USB power supply unit 110. For example, when the power supply device can output a voltage of 5 V, 9 V, 15 V, or the like, any voltage of these voltages is input to the USB power supply unit 110. The USB power supply unit 110 outputs the input voltage as it is or converts the input voltage into a voltage equivalent to a battery voltage and outputs the converted voltage.

As illustrated in FIGS. 2A and 2B, the imaging power supply unit 1072 is mounted on the imaging circuit board 202. The imaging power supply unit 1072 is a power supply circuit that converts a voltage supplied from the battery 108 or the USB power supply unit 110 via the main circuit board 201 into a voltage required by an analog power supply and a digital power supply of the image sensor 102 and outputs the converted voltage. The voltage required by each of the analog power supply and the digital power supply of the image sensor 102 is lower than the voltage from the battery 108. The voltage required by each of the analog power supply and the digital power supply of the image sensor 102 is lower than the voltage from the USB power supply unit 110. Therefore, the imaging power supply unit 1072 is a stepdown circuit that converts an input voltage supplied from the battery 108 or the USB power supply unit 110 via the main circuit board 201 into an output voltage lower than the input voltage.

A first DCDC converter 301 is a power supply circuit (stepdown circuit) that generates voltages to be input to a first linear regulator 302 and a second linear regulator 303 for the analog power supply of the image sensor 102. A first DCDC converter control unit 3011 is a control circuit that controls a switch element 3012a and a switch element 3012b so that the output voltage of the first DCDC converter 301 becomes a desired value.

The switch element 3012a and the switch element 3012b are, for example, FETs, and are switch elements constituting the first DCDC converter 301. A stepdown inductor 1Phasea (3013a) and a stepdown inductor 1Phaseb (3013b) are inductors constituting the first DCDC converter 301.

The first linear regulator 302 and the second linear regulator 303 are linear regulators that step down the output voltage of the first DCDC converter 301 to a voltage required by the analog power supply of the image sensor 102.

A second DCDC converter 311 is a power supply circuit that generates a voltage for the digital power supply of the image sensor 102. A second DCDC converter control unit 3111 is a control circuit that controls a switch element 3112a and a switch element 3112b so that the output voltage of the second DCDC converter 311 has a desired value.

The switch element 3112a and the switch element 3112b are, for example, FETs, and are switch elements constituting the second DCDC converter 311. A stepdown inductor 2Phasea (3113a) and a stepdown inductor 2Phaseb (3113b) are inductors constituting the second DCDC converter 311.

The first DCDC converter control unit 3011 and the second DCDC converter control unit 3111 are desirably DCDC converters that can perform high-speed switching operation of 3 MHz or more. The high-speed switching operation can reduce noise to an image obtained by the image sensor 102 due to a magnetic field radiated from the stepdown inductor 1Phasea (3013a), the stepdown inductor 1Phaseb (3013b), the stepdown inductor 2Phasea (3113a), and the stepdown inductor 2Phaseb (3113b).

As described above, by arranging the imaging power supply unit 1072 on the imaging circuit board 202, the voltage from the battery 108 or the voltage from the USB power supply unit 110 is sent from the imaging circuit board 201 to the imaging power supply unit 1072 of the imaging circuit board 202 via the imaging power supply FPC 203 without being stepped down. Therefore, the current flowing through the imaging power supply FPC 203 can be reduced. For example, it is assumed that the peak power consumption of the image sensor 102 is about 22 W. At this time, in a case where the imaging power supply unit 1072 is on the main circuit board 201, the current flowing through the imaging power supply FPC 203 is about 10 A. On the other hand, in a case where the imaging power supply unit 1072 is in the imaging circuit board 202, the current flowing through the imaging power supply FPC 203 can be about 2 A. As a result, the image sensor 102 is less likely to be affected by the magnetic radiation from the current flowing through the imaging power supply FPC 203.

The current flowing through the imaging power supply FPC 203 is reduced, whereby the wiring of the imaging power supply FPC 203 can be thinned. Therefore, the flexibility of the FPC is increased, and there is an advantage that the movable range can be increased for a camera shake correction mechanism.

From the viewpoint of power consumption, the current flowing through the imaging power supply FPC 203 is reduced, whereby it is possible to reduce wasteful power supply loss due to the impedance of the imaging power supply FPC 203. Since the first DCDC converter 301 can be arranged near the first linear regulator 302 and the second linear regulator 303, a low voltage can be set. Therefore, the loss of the first linear regulator 302 and the second linear regulator 303 can also be reduced.

An increase in the number of pixels and an increase in the speed of reading (including reading of all pixels) of the image sensor 102 have progressed, and it is possible to cope with an increase in power consumption.

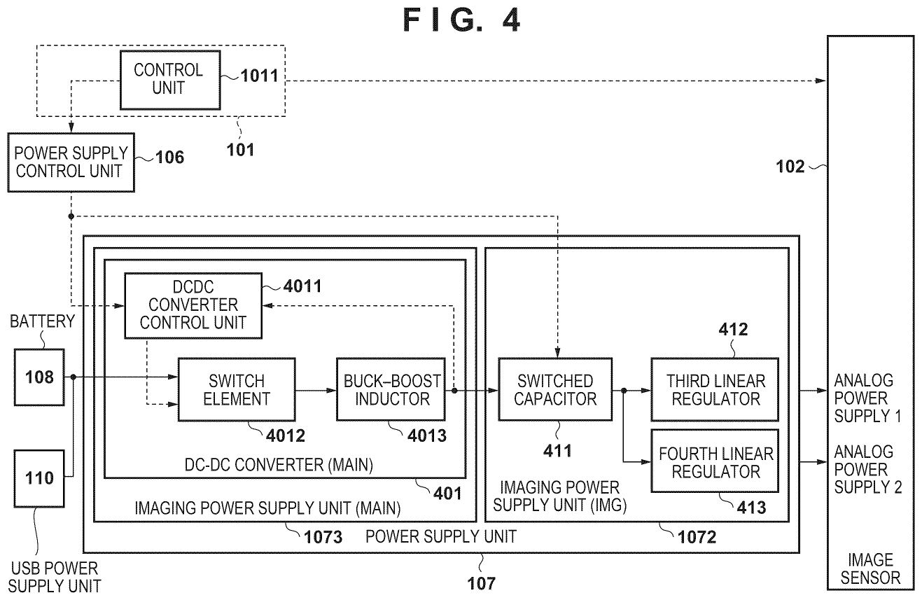

FIG. 4 is a view illustrating another example of the imaging power supply unit 1072 and the peripheral circuit configuration of FIGS. 2A and 2B.

The control unit 1011, the image sensor 102, the power supply control unit 106, the battery 108, and the USB power supply unit 110 are the same as those in FIG. 1.

When the battery 108 has two cells, the voltage from the battery 108 is about 5 V to 8.4 V. The voltage output from the USB power supply unit 110 varies depending on the power supply capability of the power supply device connected to the USB power supply unit 110. For example, when the power supply device can output a voltage of 5 V, 9 V, 15 V, or the like, any voltage of these voltages is input to the USB power supply unit 110. The USB power supply unit 110 outputs the input voltage as it is or converts the input voltage into a voltage equivalent to a battery voltage and outputs the converted voltage.

The imaging power supply unit 1073 is a power supply circuit arranged on the main circuit board 201 of FIGS. 2A and 2B, and includes a DCDC converter 401 that generates a voltage to be input to a switched capacitor 411. A DCDC converter control unit 4011 is a control circuit that controls a switch element 4012 so that the output voltage of the DCDC converter 401 becomes a desired value. The switch element 4012 is, for example, an FET, and is a switch element constituting the DCDC converter 401. A buck-boost inductor 4013 is an inductor constituting the DCDC converter 401.

The imaging power supply unit 1072 is a power supply circuit that is arranged on the imaging circuit board 202 of FIGS. 2A and 2B and generates a voltage for the analog power supply of the image sensor 102.

The switched capacitor 411 is a power supply circuit (stepdown circuit) including a plurality of capacitors and switches. The switched capacitor 411 converts the input voltage output from the DCDC converter 401 into an output voltage of 1/N (N is a natural number), and generates a voltage for the analog power supply of the image sensor 102. The output voltage from the buck-boost inductor 4013 of the imaging power supply unit 1073 is stepped down to 1/N by the switched capacitor 411. In this manner, the DCDC converter 401 converts the voltage from the battery 108 or the USB power supply unit 110 into N times the input voltage of the switched capacitor 411 and outputs the converted voltage to the imaging power supply unit 1072.

A third linear regulator 412 and a fourth linear regulator 413 are linear regulators that step down the voltage output from the switched capacitor 411 to a voltage required by the analog power supply of the image sensor 102.

As described above, in the configuration of FIG. 4, the voltage from the battery 108 or the voltage from the USB power supply unit 110 is converted into the input voltage to the switched capacitor 411 by the imaging power supply unit 1073 on the main circuit board 201 side and is output. Then, similarly to FIG. 3, the imaging power supply unit 1072 is arranged on the imaging circuit board 202, and the imaging power supply unit 1072 converts the input voltage from the imaging power supply unit 1073 into a low voltage. Therefore, the current flowing through the imaging power supply FPC 203 can be reduced. Furthermore, the imaging power supply unit 1072 in FIG. 4 does not require an inductor, and therefore the image sensor 102 is not affected by magnetic radiation from the inductor.

In the imaging power supply unit 1073, even when the voltage of the battery 108 decreases, the output voltage from the DCDC converter 401 is converted to N times the input voltage of the switched capacitor 411 and is output to the imaging power supply unit 1072. Therefore, the presence of the imaging power supply unit 1073 enables stable power supply to the image sensor 102 even when the voltage of the battery 108 decreases. Since the imaging power supply unit 1073 is arranged on the main circuit board 201, the image sensor 102 hardly receives magnetic radiation from the buck-boost inductor 4013.

On the other hand, since stepping up is performed in the DCDC converter 401 and stepping down is performed in the switched capacitor 411, the power efficiency of the entire image capturing apparatus 100 decreases. However, the

DCDC converter 401 steps down the voltage from the battery 108 or the USB power supply unit 110 in accordance with the operation voltage of the image sensor 102 and outputs, and the switched capacitor 411 outputs (through) the input voltage as it is ( 1/1 times), whereby it is also possible to operate as an efficiency priority mode.

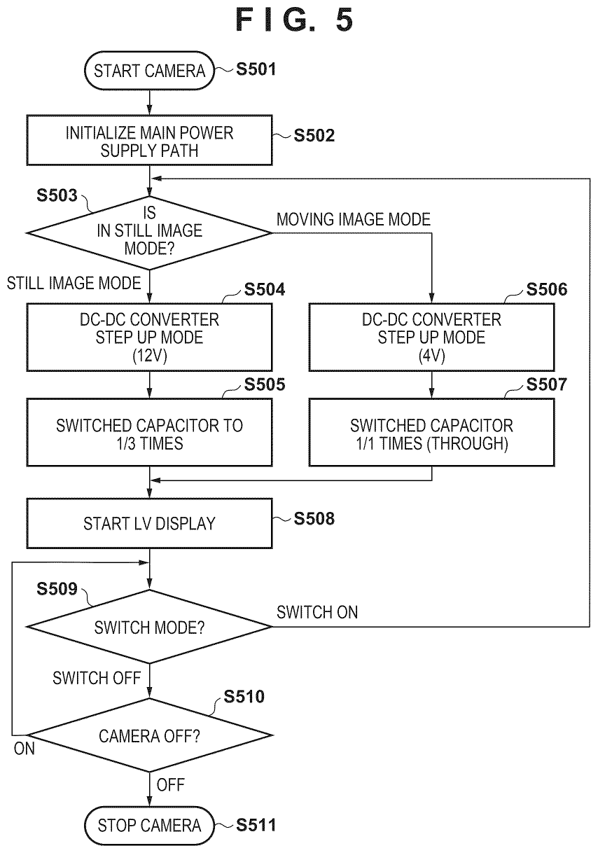

Next, FIG. 5 is a flowchart showing control content of the imaging power supply unit 1072 and the imaging power supply unit 1073 of FIG. 4 performed by the control unit 1011 and the power supply control unit 106.

In step S501, for example, when the user performs an operation such as turning on a power supply switch (not illustrated) of the image capturing apparatus 100, the control unit 1011 performs start processing of the image capturing apparatus 100.

In step S502, the power supply control unit 106 performs setting of the power supply unit 107. Here, as the setting for the DCDC converter, voltage setting, setting of a variable drive SW frequency, setting of PWM fixed control, selection of pulse frequency modulation (PFM), or the like is performed. As a setting for the switched capacitor, there is a setting for switching the magnification to 1/N (N is a natural number) such as ½ or ⅓.

In step S503, the control unit 1011 determines the operation mode of the image capturing apparatus 100. If the image capturing apparatus 100 is in the still image mode, the process proceeds to S504. If the image capturing apparatus 100 is in the moving image mode, the process proceeds to S506.

Here, the moving image mode is an example of a mode in which the reading speed of image capturing data at the time of shooting is slow and the peak value of the consumption current is relatively small, and the still image mode is an example of a mode in which the reading speed of image capturing data at the time of shooting is fast and the peak value of the consumption current is relatively large. Of the moving image mode, in a case of a mode in which the reading speed of image capturing data is high and the peak value of the consumption current is relatively large, the process may proceed to not step S506 but S504. On the contrary, of the still image mode, in a case of a mode in which the reading speed of image capturing data at the time of shooting is slow and the peak value of the consumption current is relatively small, the process may proceed to not step S504 but S506.

In step S504, the power supply control unit 106 sets the output voltage of the DCDC converter 401. Here, for example, the output voltage of the DCDC converter 401 is 12 V.

In step S505, the power supply control unit 106 sets the magnification of the switched capacitor 411. Here, the magnification of the switched capacitor 411 is set to ⅓. When a voltage of 12 V is input from the DCDC converter 401, the switched capacitor 411 converts this input voltage of 12 V into an output voltage of 4 V, which is ⅓.

On the other hand, in step S506 to which the process proceeds in the case of the moving image mode, the power supply control unit 106 sets the output voltage of the DCDC converter 401. Here, for example, the output voltage of the DCDC converter 401 is 4 V.

In step S507, the power supply control unit 106 sets the magnification of the switched capacitor 411. Here, the magnification of the switched capacitor 411 is set to 1/1. Therefore, when a voltage of 4 V is input from the DCDC converter 401 to the switched capacitor 411, the switched capacitor 411 outputs, as an output voltage, the input voltage of 4 V as it is.

In this manner, upon completing the settings of the DCDC converter 401 and the switched capacitor 411, the power supply control unit 106 starts processing of power supply by the imaging power supply unit 1073 and the imaging power supply unit 1074, and power is supplied to the image sensor 102. In step S508, the control unit 1011 starts drive of the image sensor 102 via the imaging drive control unit 1012. The control unit 1011 displays the image captured by the image sensor 102 onto the display unit 103 as a live view image via the temporary memory 1014, the image correction unit 1015, and the display image conversion unit 1016.

In step S509, the control unit 1011 determines switching of the operation mode of the image capturing apparatus 100. If switching of the operation mode occurs, the process returns to S503. If there is no switching of the operation mode, the process proceeds to S510.

In step S510, the control unit 1011 determines the state of the power supply switch (not illustrated) of the image capturing apparatus 100. If the power supply switch of the image capturing apparatus 100 is turned off, the process proceeds to S511. If the power supply switch of the image capturing apparatus 100 remains on, the process returns to S509.

In step S511, the power supply control unit 106 stops the outputs of the imaging drive control unit 1012 and the power supply unit 107, and stops the operation of the image capturing apparatus 100.

The operation of FIG. 5 increases the output voltage of the DCDC converter 401 in S504 and S505 in a case where the image capturing apparatus 100 is in a mode in which the peak current is relatively large such as the still image mode. This can reduce the peak current flowing through the imaging power supply FPC 203 in a case of supplying power to the switched capacitor 411 via the imaging power supply FPC 203.

In a case where the image capturing apparatus 100 is in a mode in which the peak current is relatively small such as the moving image mode, only the stepdown operation of the DCDC converter 401 is performed in S506 and S507. Then, by outputting (through) the input voltage as it is, the switched capacitor 411 can reduce power supply loss of the imaging power supply unit 1072 and suppress temperature rise of the image sensor 102.

In the flowchart of FIG. 5, the operation mode of the image capturing apparatus 100 is determined in step S503, but the temperature of the image sensor 105 may be determined based on the temperature data acquired by the temperature sensor 102. If the temperature of the image sensor 102 is a predetermined value or more, the process proceeds to S506, and if it is less than the predetermined value, the process proceeds to S504. That is, if the temperature of the image sensor 102 rises, control is performed such that the stepdown operation of the DCDC converter 401 is performed, the magnification of the switched capacitor 411 is set to 1/1 time, and the switched capacitor 411 outputs the input voltage as it is. This reduces the power supply loss of the imaging power supply unit 1072, and can suppress the temperature rise of the image sensor 102.

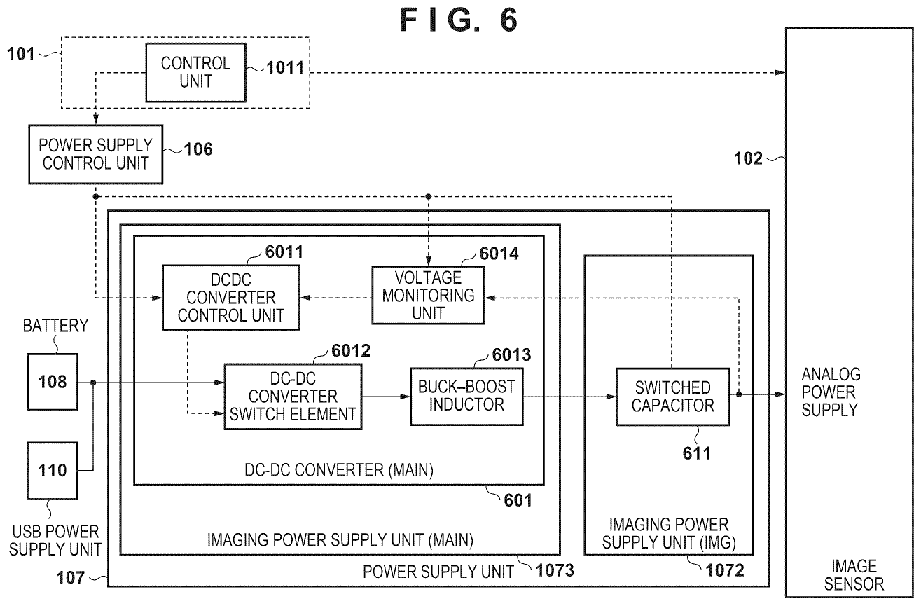

FIG. 6 is a view illustrating another example of the imaging power supply unit 1072 and the peripheral circuit configuration in FIG. 1.

The control unit 1011, the image sensor 102, the power supply control unit 106, the battery 108, and the USB power supply unit 110 are the same as those in FIG. 1.

The imaging power supply unit 1073 is a power supply circuit arranged on the main circuit board 201 of FIGS. 2A and 2B, and includes a DCDC converter 601 that generates a voltage to be input to a switched capacitor 611. A voltage monitoring unit 6014 monitors the output voltage of the switched capacitor 611 and notifies a DCDC converter control unit 6011 based on the monitoring.

The DCDC converter control unit 6011 controls a switch element 6012 such that the output voltage of the switched capacitor 611 becomes a desired value based on the notification from the voltage monitoring unit 6014. In this manner, the output voltage of the DCDC converter 601 is adjusted.

The switch element 6012 is, for example, an FET, and is a switch element constituting the DCDC converter 601. A buck-boost inductor 6013 is an inductor constituting the DCDC converter 601.

The imaging power supply unit 1072 is a power supply circuit that is arranged on the imaging circuit board 202 of FIGS. 2A and 2B and generates a voltage for the analog power supply of the image sensor 102.

The switched capacitor 611 is a power supply circuit (stepdown circuit) including a plurality of capacitors and switches. The switched capacitor 611 converts the input voltage from the DCDC converter 601 into an output voltage of 1/N (N is a natural number), and generates a voltage for the analog power supply of the image sensor 102.

In the circuit configuration of FIG. 6 above, the voltage monitoring unit 6014 monitors the output voltage of the switched capacitor 611. Then, the DCDC converter control unit 6011 controls the switch element 6012 such that the output voltage of the switched capacitor 611 becomes a desired value based on the notification from the voltage monitoring unit 6014. In this manner, the output voltage of the DCDC converter 601 is adjusted.

For example, when the input voltage of the switched capacitor 611 decreases due to the wiring resistance from the DCDC converter 601 to the switched capacitor 611, the DCDC converter control unit 6011 performs control so as to increase the output voltage of the DCDC converter 601. The output voltage of the DCDC converter 601 also changes in accordance with the magnification (1/N) of the switched capacitor 611. For example, when the magnification of the switched capacitor 611 is set to ⅓ and the output voltage of the DCDC converter 1073 is set to 12 V, the output voltage of the switched capacitor 611 is 4 V, which is ⅓ of 12 V. In this state, the voltage monitoring unit 6014 monitors the output voltage of the switched capacitor 611. When the output voltage of the switched capacitor 611 becomes smaller than 4 V, the voltage monitoring unit 6014 notifies the DCDC converter 6011 that the output voltage of the switched capacitor 611 has decreased. The DCDC converter control unit 6011 performs control so as to increase the output voltage of the DCDC converter 601 based on the notification from the voltage monitoring unit 604.

This can prevent the output voltage of the switched capacitor 611 from decreasing. Then, it is possible to prevent the output voltage from the switched capacitor 611 from falling below the lower limit of the voltage range required by the image sensor 102.

Note that control content of the imaging power supply unit 1072 and the imaging power supply unit 1073 of FIG. 6 are similar to those in the flowchart of FIG. 5.

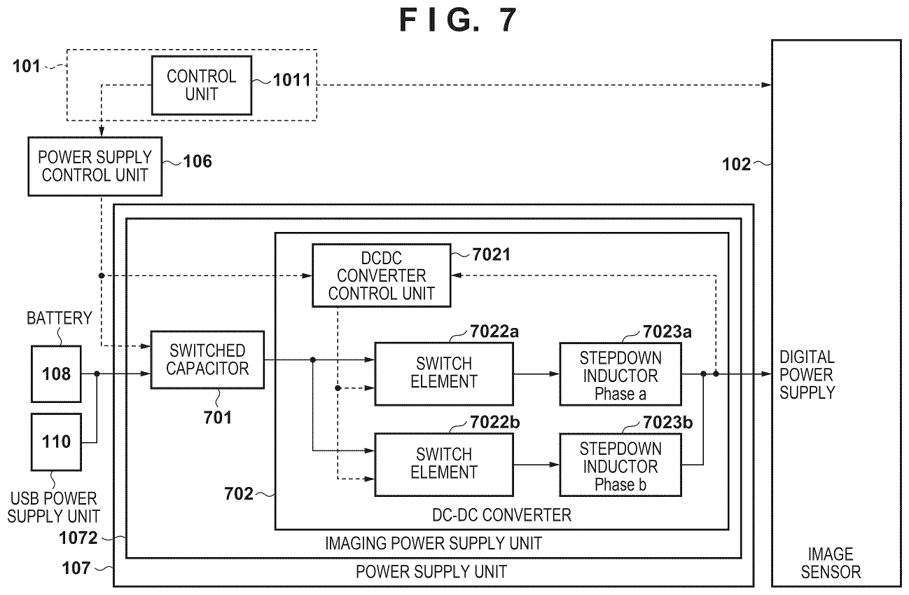

FIG. 7 is a view illustrating another example of the imaging power supply unit 1072 and the peripheral circuit configuration in FIG. 1.

The control unit 1011, the image sensor 102, the power supply control unit 106, the battery 108, and the USB power supply unit 110 are the same as those in FIG. 1.

The imaging power supply unit 1072 arranged on the imaging circuit board 202 is a power supply circuit that converts a voltage supplied from the battery 108 or the USB power supply unit 110 via the main circuit board 201 into a voltage required by the digital power supply of the image sensor 102 and outputs the converted voltage.

A DCDC converter 702 is a power supply circuit that steps down the voltage output from a switched capacitor 701 (stepdown circuit) and generates a voltage for the digital power supply of the image sensor 102.

A DCDC converter control unit 7021 is a control circuit that controls a switch element 7022a and a switch element 7022b so that the output voltage of the DCDC converter 702 becomes a desired value.

The switch element 7022a and the switch element 7022b are, for example, FETs, and are switch elements constituting the DCDC converter 702. A stepdown inductor Phasea (7023a) and a stepdown inductor Phaseb (7023b) are inductors constituting the DCDC converter 702.

The switched capacitor 701 is a power supply circuit including a plurality of capacitors and switches. The switched capacitor 701 converts an input voltage output from the battery 108 or the USB power supply unit 110 into an output voltage of 1/N, and generates a voltage for an input power supply of the DCDC converter 702.

The DCDC converter 702 has minimum ON times of the switch elements 7022a and 7022b that are different depending on the product type.

The minimum ON time required according to a variable switch frequency (SW frequency) is obtained as follows.

$$Tswon [ μ s ] = 1 / Fsw [ MHz ] \times Vout [ V ] / Vin [ V ]$$

$$( Tswon \text{: minimum ON time} , Fsw : SW frequency , Vout : \text{output voltage} , Vin \text{: input voltage} )$$

From the above equation, when the DCDC converter 702 is operated at a stable SW frequency, it is necessary to appropriately set the input voltage of the DCDC converter 702.

For example, the minimum ON time of the switch elements 7022a and 7022b is assumed to be 40 ns. It is assumed that 1.25 V is required as the input voltage of the image sensor 102.

When it is desired to stably operate the DCDC converter 702 at 5.0 MHz, the input voltage can be received only up to 6.25 V.

When the battery 108 has two cells, the voltage of the battery 108 is about 5 V to 8.4 V. Therefore, when the voltage of battery 108 is converted into ½ by the switched capacitor 701, the output voltage of the switched capacitor 701 becomes 2.5 V to 4.2 V. Therefore, the DCDC converter 702 can be stably operated at 5.0 MHz.

When the battery 108 has 3 cells, the voltage of the battery 108 is about 9 V to 12.6 V. Therefore, when the voltage of battery 108 is converted into ⅓ by the switched capacitor 701, the output voltage of the switched capacitor 701 becomes 3.0 V to 4.2 V. Therefore, the DCDC converter 702 can be stably operated at 5.0 MHz.

When the input voltage of the switched capacitor 701 is high including the DC coupler operation and USB power supply, the voltage of the battery 108 is converted into a voltage of ⅓ by the switched capacitor 701 and output to the DCDC converter 702, whereby the DCDC converter 702 can be stably operated at 5.0 MHz.

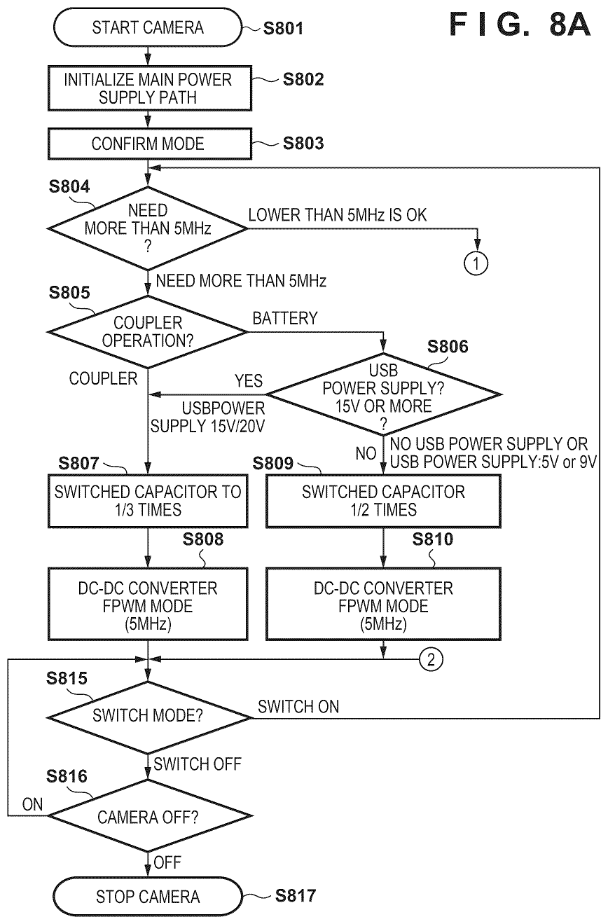

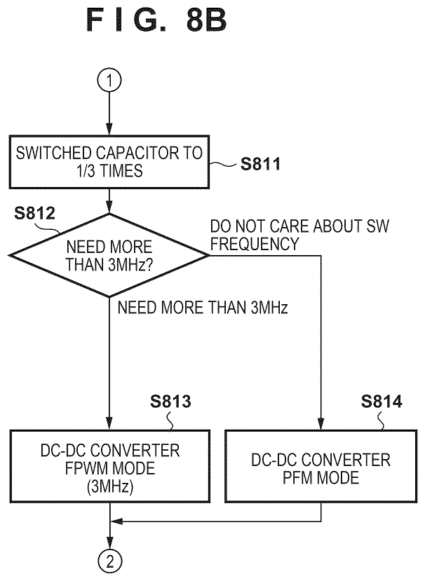

Next, FIGS. 8A and 8B are flowcharts showing control content of the imaging power supply unit 1072 performed by the control unit 1011 and the power supply control unit 106.

In step S801, for example, when the user performs an operation such as turning on the power supply switch (not illustrated) of the image capturing apparatus 100, the control unit 1011 performs start processing of the image capturing apparatus 100.

In step S802, the power supply control unit 106 performs setting of the power supply unit 107. Here, as the setting for the DCDC converter, voltage setting, setting of a drive SW frequency, setting of PWM fixed control, selection of pulse frequency modulation (PFM), or the like is performed. As a setting for the switched capacitor, a setting for switching the magnification to 1/N (N is a natural number) such as ½ or ⅓ is performed.

In step S803, the current operation mode of the image capturing apparatus 100 is confirmed.

In step S804, the control unit 1011 determines whether or not a frequency of 5 MHz or more is required as the switching frequency of the DCDC converter 702.

It is known that when a CMOS image sensor receives magnetic noise, induced electromotive force is generated in an internal circuit, and image quality may deteriorate due to fluctuation in the output of a pixel signal. The frequency of the magnetic noise at which image quality deterioration is likely to occur varies depending on the read cycle of the pixel data and the like. The higher the frequency of the magnetic noise is, the less the image quality deterioration tends to occur. Furthermore, the image quality deterioration tends to be more noticeable in a shooting mode with higher ISO sensitivity.

Based on the above, in order to prevent the image quality from deteriorating, it is necessary to set the frequency of the magnetic noise radiated from the DCDC converter 702 not to match a drive frequency at which the image quality is likely to deteriorate in accordance with the operation mode of the image capturing apparatus 100.

In step S804, for example, if the image capturing apparatus 100 is in a shooting mode with the ISO sensitivity of 12800 or more, it is determined that the drive frequency of the DCDC converter 702 needs to be set to 5 MHz or more, and the process proceeds to S805. In a case of being not in the shooting mode with the ISO sensitivity of 12800 or more, image quality deterioration does not occur even if the switching frequency of the DCDC converter 702 is 5 MHz or less. Therefore, in a case of being not in the shooting mode with the ISO sensitivity of 12800 or more, the process proceeds to S811.

In step S805, the control unit 1011 determines whether or not the DC coupler is inserted into the mounting portion of the battery 108. If the DC coupler is inserted, the process proceeds to S807. If the DC coupler is not inserted and a lithium ion battery is inserted, the process proceeds to S806.

In step S806, the control unit 1011 determines whether or not an external power supply device is connected to the USB power supply unit 110. If an external power supply device is connected to the USB power supply unit 110, it is determined whether or not a voltage supplied from the external power supply device is 15 V or more. If a voltage of 15 V or more is supplied from the external power supply device, the process proceeds to S807. If the voltage supplied from the external power supply device is not 15 V or more (e.g., 5 V or 9 V), or if the external power supply device is not connected to the USB power supply unit 110 and the image capturing apparatus 100 operates only with the supply power from the lithium ion battery inserted into the battery 108, the process proceeds to S809.

In step S807, the power supply control unit 106 sets the magnification of the switched capacitor 701 to ⅓.

In step S808, the power supply control unit 106 sets the DCDC converter 702 to a PWM control mode with a fixed switching frequency of 5 MHz.

In step S809, the power supply control unit 106 sets the magnification of the switched capacitor 701 to ½.

In step S810, the power supply control unit 106 sets the DCDC converter 702 to the PWM control mode with a fixed switching frequency of 5 MHz.

In step S811, the power supply control unit 106 sets the magnification of the switched capacitor 701 to ⅓.

In step S812, the control unit 1011 determines whether or not a frequency of 3 MHz or more is required as the switching frequency of the DCDC converter 702.

For example, in a case where the image capturing apparatus 100 is in a shooting mode with the ISO sensitivity of 6400 or more and less than 12800, it is determined that the switching frequency of the DCDC converter 702 is required to be 3 MHz or more, and the process proceeds to S813. If the ISO sensitivity is not 6400 or more, image quality does not deteriorate even if the switching frequency of the DCDC converter 702 is 3 MHz or less. If the ISO sensitivity is not 6400 or more, the process proceeds to S814. Alternatively, in a case where the image capturing apparatus 100 is in an operation mode (e.g., a live view display mode) in which recording of a shot image is not performed, there is no problem even if the image quality deteriorates. Therefore, the process may proceed to S814 in the case of the operation mode in which the shot image is not recorded.

In step S813, the power supply control unit 106 sets the DCDC converter 702 to the PWM control mode with a fixed switching frequency of 3 MHz.

In step S814, the power supply control unit 106 changes the switching of the DCDC converter 702 to the pulse frequency modulation (PFM) operation. In the PFM operation mode, the switching frequency of the DCDC converter 702 changes according to the consumption current. Basically, when the current consumption is small, the switching frequency decreases and the power supply efficiency improves. For example, it is assumed that the DCDC converter 702 operates at 1 MHz when the consumption current is 500 mA and operates at 3 MHz when the consumption current is 1 A.

In step S815, the control unit 1011 determines whether or not the operation mode of the image capturing apparatus 100 is switched. If the operation mode is switched, the process returns to S804. If the operation mode is not switched, the process proceeds to S816.

In step S816, the control unit 1011 determines the state of the power supply switch (not illustrated) of the image capturing apparatus 100. If the power supply switch of the image capturing apparatus 100 is turned off, the process proceeds to S817. If the power supply switch of the image capturing apparatus 100 remains on, the process returns to S815.

In step S817, the power supply control unit 106 stops the outputs of the imaging drive control unit 1012 and the power supply unit 107, and stops the operation of the image capturing apparatus 100.

By the operation of the flowcharts of FIGS. 8A and 8B, in a case where the image capturing apparatus 100 is in the shooting mode with the ISO sensitivity of 12800 or more, the output voltage of the switched capacitor 701 is adjusted so that the switching frequency of the DCDC converter 702 can be maintained at 5 MHz even when the voltage of the power supply source of the image capturing apparatus 100 changes.

For example, in S807, a voltage of 15 V is input to the switched capacitor 701 from the USB power supply unit 110 or the DC coupler. The switched capacitor 701 converts this input voltage of 15 V into an output voltage of 5 V, which is ⅓, and outputs the output it. The output voltage of 5 V from the switched capacitor 701 is input to the DCDC converter 702. In a case where the image sensor 102 requires a voltage of 1.25 V, the minimum ON time needs to be 50 ns or less in order for the DCDC converter 702 to operate at 5 MHz. The minimum ON time of the DCDC converter 702 is, for example, 40 ns, and is operable at a switching frequency of 5 MHz.

For example, in S809, a voltage of 4.5 V from the battery 108 is input to the switched capacitor 701. The switched capacitor 701 converts this input voltage of 4.5 V into an output voltage of 2.25 V of ½, and outputs the output it. This output voltage of 2.25 V from the switched capacitor 701 is input to the DCDC converter 702. In a case where the image sensor 102 requires the voltage of 1.25 V, a minimum OFF time needs to be 89 ns or less in order for the DCDC converter 702 to operate at 5 MHz. The minimum OFF time of the DCDC converter 702 is, for example, 40 ns, and is operable at a switching frequency of 5 MHz.

As described above, the frequency of the magnetic noise radiated from the DCDC converter 702 can be avoided from matching the frequency at which the image quality of the image sensor 102 is likely to deteriorate, and image quality deterioration can be reduced.

In the case where the image capturing apparatus 100 is in the shooting mode with the ISO sensitivity of 6400 or more and less than 12800, the output voltage of the switched capacitor 701 is adjusted so that the switching frequency of the DCDC converter 702 can be maintained at 3 MHz. By this, the frequency of the magnetic noise radiated from the DCDC converter 702 can be avoided from matching the frequency at which the image quality of the image sensor 102 is likely to deteriorate, and image quality deterioration can be reduced. As compared with the case where the DCDC converter 702 is operated at 5 MHz, power supply loss can be reduced, and image quality deterioration due to temperature rise of the image sensor 102 can be reduced.

Furthermore, in a case where the image capturing apparatus 100 is in a shooting mode with ISO sensitivity of less than 6400 or in the operation mode (e.g., a live view display mode) in which recording of a shot image is not performed, the switching frequency of the DCDC converter 702 decreases to less than 3 MHz. This can reduce power supply loss, and can reduce image quality deterioration due to temperature rise of the image sensor 102.

Note that the type of the operation mode of the image capturing apparatus 100 described with reference to FIGS. 8A and 8B and the switching frequency of the DCDC converter 702 in each operation mode are examples. For another operation mode of the image capturing apparatus 100, the DCDC converter 702 may be controlled so as to have another switching frequency in order to reduce image quality deterioration.

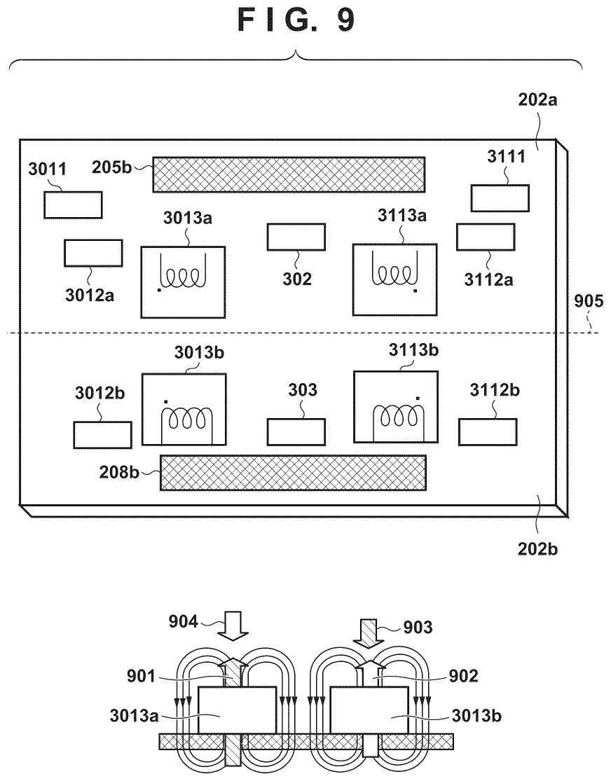

FIG. 9 is a view illustrating a layout of each component of the imaging power supply unit 1072 of FIG. 3 arranged on the imaging circuit board 202 of FIGS. 2A and 2B.

The connector 205b and the connector 208b are the same as those in FIGS. 2A and 2B. The first DCDC converter control unit 3011, the switch element 3012a, the switch element 3012b, the stepdown inductor 1Phasea (3013a), the stepdown inductor 1Phaseb (3013b), the first linear regulator 302, the second linear regulator 303, the second DCDC converter control unit 3111, the switch element 3112a, the switch element 3112b, the stepdown inductor 2Phasea (3113a), and the stepdown inductor 2Phaseb (3113b) are the same as those in FIG. 3.

A division line 905 is a division line that bisects the area of the imaging circuit board 202. The imaging circuit board 202 is divided into a region 202a and a region 202b having an equal area by the division line 905.

In the region 202a, the first DCDC converter control unit 3011, the switch element 3012a, the stepdown inductor 1Phasea (3013a), the first linear regulator 302, the second DCDC converter control unit 3111, the switch element 3112a, and the stepdown inductor 2Phasea (3113a) are arranged.

In the region 202b, the switch element 3012b, the stepdown inductor 1Phaseb (3013b), the second linear regulator 303, the switch element 3112b, and the stepdown inductor 2Phaseb (3113b) are arranged.

When each component (a plurality of circuit elements having the same function) is laid out as in FIG. 9, the number of inductors arranged in the region 202a is equal to the number of inductors arranged in the region 202b. The number of switch elements arranged in the region 202a is equal to the number of switch elements arranged in the region 202b. The number of linear regulators arranged in the region 202a is equal to the number of linear regulators arranged in the region 202b. This can prevent the heat due to the loss generated in the inductor, the switch element, and the linear regulator from concentrating on a partial region of the imaging circuit board 202, and can reduce the temperature rise of the image sensor 102.

Note that although the division line 905 is a division line that bisects the area of the imaging circuit board 202, the circuit board may be divided by a division line that divides the circuit board into N equal parts (N is an integer of 2 or more), and the number of inductors, switch elements, and linear regulators arranged in each division region may be made equal. By doing as described above, a heat generation portion can be dispersed and image quality deterioration can be prevented.

The stepdown inductor 1Phasea (3013a) and the stepdown inductor 1Phaseb (3013b) are arranged such that the orientation of the magnetic field generated by the stepdown inductor 1Phasea (3013a) and the orientation of the magnetic field generated by the stepdown inductor 1Phaseb (3013b) are the same when a positive current flows in the direction of the image sensor 102 (not illustrated).

A magnetic field 901 and a magnetic field 903 are represented by arrows indicating the orientation of the magnetic field generated from the stepdown inductor 1Phasea (3013a) when the positive current flows in the direction of the image sensor 102 (not illustrated) from the stepdown inductor 1Phasea (3013a).

A magnetic field 902 and a magnetic field 904 are represented by arrows indicating the orientation of the magnetic field generated from the stepdown inductor 1Phaseb (3013b) when the positive current flows in the direction of the image sensor 102 (not illustrated) from the stepdown inductor 1Phaseb (3013b). When the positive current flows in the direction of the image sensor 102 (not illustrated) from the stepdown inductor 1Phasea (3013a) and the stepdown inductor 1Phaseb (3013b), the magnetic field 901 and the magnetic field 904 are in opposite directions inside the winding of the stepdown inductor 1Phasea (3013a) and cancel each other out. Inside the winding of the stepdown inductor 1Phaseb (3013b), the magnetic field 903 and the magnetic field 902 are in opposite directions and cancel each other out.

In this manner, when even numbers of the stepdown inductor 1Phasea (3013a) and the stepdown inductor 1Phaseb (3013b) are arranged in the arrangement orientation illustrated in FIG. 9, the generated magnetic fields cancel each other out. Therefore, image quality deterioration due to magnetic noise in the image captured by the image sensor 102 can be reduced.

Note that in FIG. 9, the magnetic field 901 and the magnetic field 904, and the magnetic field 903 and the magnetic field 902 are perpendicular to the image sensor 102, and are directions in which they cancel each other out. However, the stepdown inductor 1Phasea (3013a) and the stepdown inductor 1Phaseb (3013b) may be arranged so as to be parallel to the image sensor 102 and in directions in which they cancel each other out.

The orientation of the arrangement of the stepdown inductor 2Phasea (3113a) and the stepdown inductor 2Phaseb (3113b) is similar to that of the stepdown inductor 1Phasea (3013a) and the stepdown inductor 1Phaseb (3013b). By doing as described above, the magnetic fields entering the image sensor 102 are canceled out by each other, and image quality deterioration can be prevented.

### Second Embodiment

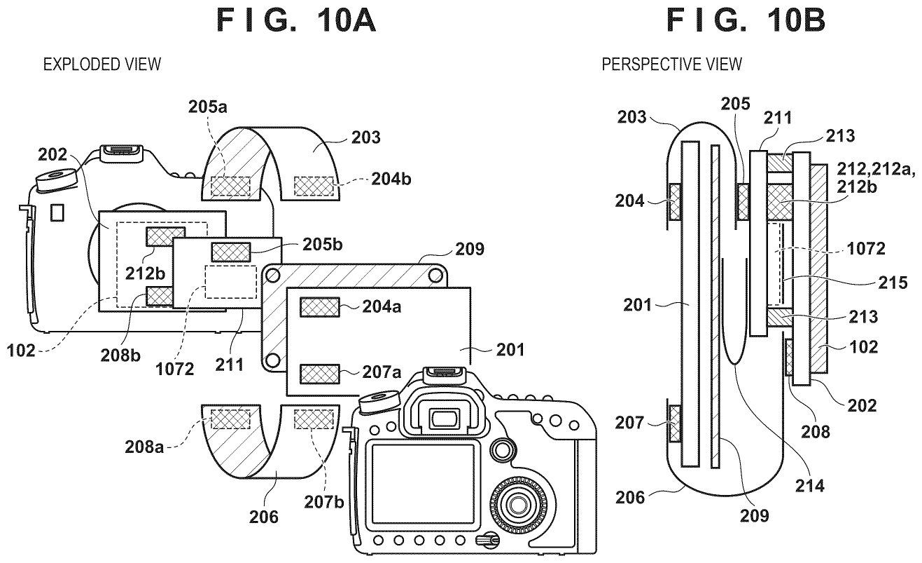

Hereinafter, an image capturing apparatus 200 of the second embodiment of the present invention will be described. FIGS. 10A and 10B are an exploded view and a perspective view illustrating a mounting configuration of the image capturing apparatus 200. Note that in FIGS. 10A and 10B, parts performing the same functions as those in FIGS. 2A and 2B are given the same reference numerals as those in FIGS. 2A and 2B.

In FIGS. 10A and 10B, the main circuit board 201, the imaging circuit board 202, and an imaging power supply circuit board 211 are arranged in a housing of the image capturing apparatus 200.

The main circuit board 201 is mounted with the CPU 101 and the power supply unit 107. The imaging circuit board 202 is mounted with the image sensor 102 of FIG. 1, and in order for the image sensor 102 to efficiently capture light, the imaging circuit board 202 is arranged on a side closer to a lens than the main circuit board 201. The imaging power supply circuit board 211 is mounted with the imaging power supply unit 1072 of FIG. 1.

The chassis 209 is connected to the main circuit board 201, and plays a role of enhancing rigidity and releasing heat to the housing.

Power is supplied from the power supply unit 107 on the main circuit board 201 to the imaging power supply unit 1072 on the imaging power supply circuit board 211 through the following path. First, the imaging power supply FPC 203 is connected to the main circuit board 201 via the imaging power supply MAIN connectors 204 (204a and 204b). The imaging power supply FPC 203 is connected to the imaging power supply circuit board 211 via the imaging power supply IMG connectors 205 (205a and 205b). The imaging power supply FPC 203 has a power transmission line for transmitting power from the main circuit board 201 to the imaging power supply circuit board 211. Then, power is supplied from the power supply unit 107 mounted on the main circuit board 201 to the imaging power supply unit 1072 through the path of the connectors 204a and 204b→the FPC 203→the IMG connectors 205a and 205b. The imaging power supply circuit board 211 is fixedly connected to the imaging circuit board 202 via imaging power supply circuit board connectors 212 (212a and 212b), and power is supplied from the imaging power supply unit 1072 to the image sensor 102.

Transmission of a data signal from the image sensor 102 on the imaging circuit board 202 to the CPU 101 on the main circuit board 201 and transmission of a control signal from the CPU 101 to the image sensor 102 are performed through the following path. First, the imaging signal FPC 206 is connected to the imaging circuit board 202 via the imaging signal IMG connectors 208 (208a and 208b). The imaging signal FPC 206 is connected to the main circuit board 201 via the imaging signal MAIN connectors 207 (207a and 207b). Then, a data signal of the image sensor 102 is transmitted to the CPU 101 via the main circuit board 201 through the path of the connectors 208a and 208b→the FPC 206→the connectors 207a and 207b. A control signal of the CPU 101 is transmitted to the image sensor 102 through the reverse path.

A heat dissipation member 213 is, for example, a rubber-like member having high thermal conductivity. The heat dissipation member 213 connects the imaging circuit board 202 and the imaging power supply circuit board 211 and has an effect of dispersing heat of the image sensor 102 on the imaging circuit board 202 from the imaging circuit board 202 to the imaging power supply circuit board 211.

A heat dissipation sheet 214 is, for example, a bendable sheet-like member having high thermal conductivity. The heat dissipation sheet 214 is arranged on a surface of one side of the imaging power supply circuit board 211 facing the main circuit board 201, is connected to the chassis 209, and has an effect of releasing heat of the imaging power supply circuit board 211 to the chassis 209. The surface of the imaging power supply circuit board 211 on the side close to the main circuit board 201 is not mounted with an electrical component, and only on the surface on the side close to the imaging circuit board 202 is mounted with the imaging power supply unit 1072. This can increase an area where the heat dissipation sheet 214 and the imaging power supply circuit board 211 are in contact with each other, and can improve heat dissipation.

A magnetic shield sheet 215 is, for example, a sheet-shaped magnetic member that shields a magnetic field. The magnetic shield sheet 215 is mounted between the imaging circuit board 202 and the imaging power supply circuit board 211, and has an effect of reducing electromagnetic field noise radiated from the imaging power supply unit 1072 to the image sensor 102.

The image capturing apparatus 200 is equipped with a camera shake correction mechanism that detects camera shake and operates (moves) the imaging circuit board 202 according to the detection amount. The imaging power supply circuit board 211 connected to the imaging circuit board 202 via the imaging power supply circuit board connectors 212 is a movable unit that can physically move for image blur correction. On the other hand, the main circuit board 201 and the chassis 209 are non-movable units.

The imaging power supply FPC 203, the imaging signal FPC 206, and the heat dissipation sheet 214 that connect the movable unit and the non-movable units are made of a sufficiently soft material. The imaging power supply FPC 203 connects the main circuit board 201, which is a non-movable unit, and the imaging power supply circuit board 211, which is a movable unit, via the imaging power supply MAIN connectors 204 (204a and 204b) and the imaging power supply IMG connectors 205 (205a and 205b). The imaging signal FPC 206 connects the main circuit board 201, which is a non-movable unit, and the imaging circuit board 202, which is a movable unit, via the imaging signal MAIN connectors 207 (207a and 207b) and the imaging signal IMG connectors 208 (208a and 208b).

As in FIGS. 10A and 10B, the imaging power supply unit 1072 is mounted not on the imaging circuit board 202 but on the imaging power supply circuit board 211, whereby heat can be prevented from being transferred to the image sensor 102 when the imaging power supply unit 1072 generates heat due to power supply loss. This can prevent image quality deterioration.

Note that the configurations of the imaging power supply unit 1072 and the peripheral circuit mounted on the imaging power supply circuit board 211 are the same as those in FIGS. 3, 4, 6, and 7 of the first embodiment. A control method of the imaging power supply unit 1072 and the peripheral circuit is the same as that in FIGS. 5 and 8 of the first embodiment.

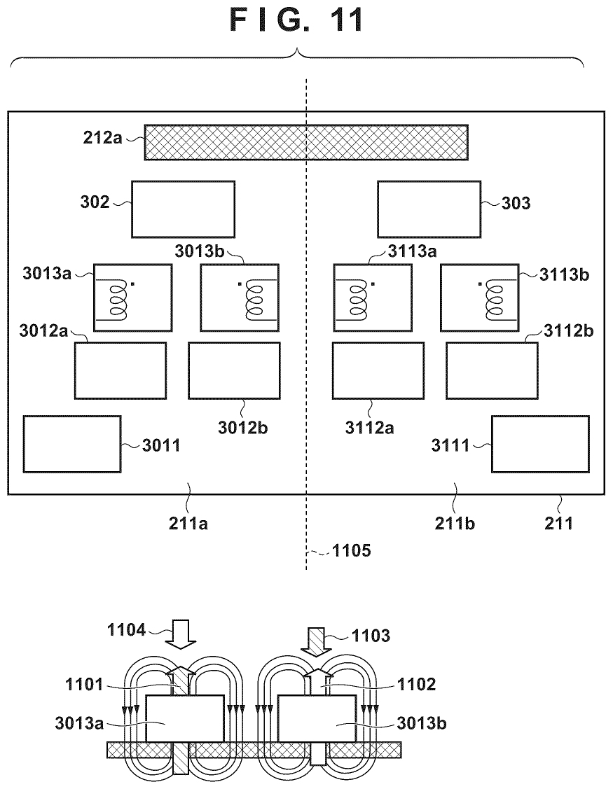

FIG. 11 is a view illustrating a layout of each component of the imaging power supply unit 1072 of FIG. 3 arranged on the imaging power supply circuit board 211 of FIGS. 10A and 10B.

The connector 212a is connected to the connector 212b on the imaging circuit board 202 of FIGS. 10A and 10B. The first DCDC converter control unit 3011, the switch element 3012a, the switch element 3012b, the stepdown inductor 1Phasea (3013a), the stepdown inductor 1Phaseb (3013b), the first linear regulator 302, the second linear regulator 303, the second DCDC converter control unit 3111, the switch element 3112a, the switch element 3112b, the stepdown inductor 2Phasea (3113a), and the stepdown inductor 2Phaseb (3113b) are the same as those in FIG. 3.

A division line 1105 is a division line that bisects the area of the imaging power supply circuit board 211. The imaging power supply circuit board 211 is divided into a region 211a and a region 211b having an equal area by the division line 1105.

In the region 211a, the first DCDC converter control unit 3011, the switch element 3012a, the switch element 3012b, the stepdown inductor 1Phasea (3013a), the stepdown inductor 1Phaseb (3013b), and the first linear regulator 302 are arranged.

In the region 211b, the second DCDC converter control unit 3111, the switch element 3112a, the switch element 3112b, the stepdown inductor 2Phasea (3113a), the stepdown inductor 2Phaseb (3113b), and the second linear regulator 303 are arranged.

When each component is laid out as in FIG. 11, the number of inductors arranged in the region 211a is equal to the number of inductors arranged in the region 211b. The number of switch elements arranged in the region 211a is equal to the number of switch elements arranged in the region 211b. The number of linear regulators arranged in the region 211a is equal to the number of linear regulators arranged in the region 211b. This can prevent the heat due to the loss generated in the inductor, the switch element, and the linear regulator from concentrating on a partial region of the imaging power supply circuit board 211, and can reduce the temperature rise of the image sensor 102.

Note that although the division line 1105 is a division line that bisects the area of the imaging power supply circuit board 211, the circuit board may be divided by a division line that divides the circuit board into N equal parts (N is an integer of 2 or more), and the number of inductors, switch elements, and linear regulators arranged in each division region may be made equal. By arranging as described above, the heat generation portion can be dispersed and image quality deterioration due to temperature rise can be prevented.

The stepdown inductor 1Phasea (3013a) and the stepdown inductor 1Phaseb (3013b) are arranged such that the orientation of the magnetic field generated by the stepdown inductor 1Phasea (3013a) and the orientation of the magnetic field generated by the stepdown inductor 1Phaseb (3013b) are the same when a positive current flows in the direction of the image sensor 102 (not illustrated).

A magnetic field 1101 and a magnetic field 1103 are represented by arrows indicating the orientation of the magnetic field generated from the stepdown inductor 1Phasea (3013a) when the positive current flows in the direction of the image sensor 102 (not illustrated) from the stepdown inductor 1Phasea (3013a).

A magnetic field 1102 and a magnetic field 1104 are represented by arrows indicating the orientation of the magnetic field generated from the stepdown inductor 1Phaseb (3013b) when the positive current flows in the direction of the image sensor 102 (not illustrated) from the stepdown inductor 1Phaseb (3013b).

When the positive current flows in the direction of the image sensor 102 (not illustrated) from the stepdown inductor 1Phasea (3013a) and the stepdown inductor 1Phaseb (3013b), the magnetic field 1101 and the magnetic field 1104 are in opposite directions inside the winding of the stepdown inductor 1Phasea (3113a) and cancel each other out. The magnetic field 1103 and the magnetic field 1102 are in opposite directions inside the winding of the stepdown inductor 1Phaseb (3013b) and cancel each other out.

In this manner, when the stepdown inductor 1Phasea (3013a) and the stepdown inductor 1Phaseb (3013b) are arranged in the orientation illustrated in FIG. 11, the generated magnetic fields cancel each other out. Therefore, image quality deterioration due to magnetic noise in the image captured by the image sensor 102 can be reduced.

Note that in FIG. 11, the magnetic field 1101 and the magnetic field 1104, and the magnetic field 1103 and the magnetic field 1102 are perpendicular to the image sensor 102, and are directions in which they cancel each other out. However, the stepdown inductor 1Phasea (3013a) and the stepdown inductor 1Phaseb (3013b) may be arranged so as to be parallel to the image sensor 102 and in directions in which they cancel each other out.

The arrangement orientation of the stepdown inductor 2Phasea (3113a) and the stepdown inductor 2Phaseb (3113b) is similar to that of the stepdown inductor 1Phasea (3013a) and the stepdown inductor 1Phaseb (3013b).

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-076088, filed May 8, 2024, which is hereby incorporated by reference herein in its entirety.

What is claimed is:

1. An image capturing apparatus comprising:
a first circuit board mounted with an image sensor;
a second circuit board that is fixedly connected to the first circuit board and supplies power to the first circuit board;
a main circuit board that supplies power to the second circuit board;
a flexible circuit board connecting the main circuit board and the second circuit board,
wherein the main circuit board supplies a first voltage higher than a voltage at which the image sensor operates to the second circuit board via the flexible circuit board, and the second circuit board includes a stepdown circuit that converts the first voltage into a second voltage lower than the first voltage and outputs the second voltage to the image sensor, and
the stepdown circuit is a DCDC converter including an inductor.

2. The image capturing apparatus according to claim 1, wherein the DCDC converter operates at a switching frequency of 3 MHz or more.

3. The image capturing apparatus according to claim 1, wherein the stepdown circuit is a DCDC converter including an inductor, and the stepdown circuit can operate in a mode in which a switching frequency is fixed.

4. The image capturing apparatus according to claim 1, wherein the stepdown circuit is a DCDC converter including an inductor, the stepdown circuit that can operate in a mode in which a switching frequency is variable, and the DCDC converter changes the switching frequency in accordance with an operation mode of the image capturing apparatus.

5. The image capturing apparatus according to claim 4, wherein the switching frequency of the DCDC converter is reduced in an operation mode in which an image captured by the image sensor is not recorded.

6. The image capturing apparatus according to claim 1, wherein the stepdown circuit is a DCDC converter that operates with an even number of inductors, and the inductors are arranged in an orientation in which a magnetic field in a direction penetrating the image sensor or a magnetic field in a direction parallel to the image sensor is canceled out by each other.

7. The image capturing apparatus according to claim 1, wherein the stepdown circuit includes a plurality of circuit elements having a same function, and when an area of the first circuit board is divided into N equal parts where N is an integer of 2 or more, a same number of the circuit elements having the same function are arranged in each division region.

8. The image capturing apparatus according to claim 7, wherein the stepdown circuit is a DCDC converter including a plurality of inductors, and a same number of the inductors are arranged in each division region.

9. The image capturing apparatus according to claim 7, wherein the stepdown circuit is a DCDC converter including a plurality of switch elements, and a same number of the switch elements are arranged in each division region.

10. The image capturing apparatus according to claim 1, wherein a magnetic member is arranged between the first circuit board and the second circuit board.

11. The image capturing apparatus according to claim 1, wherein a heat dissipation member is arranged between the first circuit board and the second circuit board.

12. The image capturing apparatus according to claim 1, wherein a heat dissipation member is arranged on a surface of one side of the second circuit board.

13. The image capturing apparatus according to claim 12, wherein the heat dissipation member is arranged on a surface of the second circuit board, the surface facing the main circuit board.

14. The image capturing apparatus according to claim 1, wherein the stepdown circuit includes a linear regulator.

15. The image capturing apparatus according to claim 1, wherein the stepdown circuit includes a switched capacitor.

16. The image capturing apparatus according to claim 1 comprising;
a second flexible circuit board that connects the main circuit board and the first circuit board, wherein
the main circuit board sends a control signal for controlling the image sensor to the first circuit board via the second flexible circuit board, and receives image data acquired by the image sensor via the second flexible circuit board.

17. The image capturing apparatus according to claim 1, wherein the image sensor is a CMOS image sensor.

18. The image capturing apparatus according to claim 17, wherein the image sensor is a CMOS image sensor of a stacked type in which a wiring layer for reading out a pixel signal is arranged on a back surface of a pixel.

19. The image capturing apparatus according to claim 1, wherein the first circuit board is physically movable for image blur correction.
